(19) United States
(12) Patent Application Publication
(10) Pub. No.: US 2015/0371535 A1
(43) Pub. Date: Dec. 24, 2015

(54) REMOTE CONTROLLER WITH KEYPAD PROTECTOR

(71) Applicant: DANTE RAMEL OLIVAR, Antipolo (PH)

(72) Inventor: DANTE RAMEL OLIVAR, Antipolo (PH)

(21) Appl. No.: 14/744,054

(22) Filed: Jun. 19, 2015

(30) Foreign Application Priority Data
Jun. 20, 2014 (PH) 2/2014/000381

(51) Int. Cl. G08C 23/04

(52) U.S. Cl. CPC G08C 23/04; G08C 2201/92

(57) ABSTRACT

This utility model relates to a remote controller for televisions, video recorders/players, air conditioners and the like with keypad protector comprising an elongated generally flat housing being defined by a pair of upper and lower shells, provided on said upper 5 shell, a keypad having different sizes of push buttons being received by the plurality of different kinds of slots of said upper shell, said keypad being intended for changing channels and for setting up of different kinds of program activities, such as on/off button, mute button or for accessing the menu options thereof, characterized in that said housing further provided with keypad protector being defined by a flat rectangular support disposed at the back portion thereof, a pair of opposing raised members extending outwardly from the rear end of said rectangular support, and a protecting block being provided at the opposing forward end of said rectangular support, said protecting block having chamfered corners to provide a way to roll said remote controller in a lying position should it be laid down in an upside down position thereof.

### FIELD OF THE UTILITY MODEL

This utility model relates generally to remote control devices for operation of electronic appliances such as television, video recorders/players and the like, but more particularly to a remote controller having a keypad protector that is integral to the housing thereof. Said keypad protector is provided thereof to prevent the accidental pushing of buttons in the keypad which causes the sudden change of channels being watched, sudden increase/decrease of volume, or other functionalities that when pushed accidentally, might create a possibility wherein the TV program a user is watching would be transferred to another channel causing him/her to miss a certain scene, or may cause some settings on said television to be changed or be deleted.

### BACKGROUND OF THE UTILITY MODEL

Remote control units for televisions are used to control all operations of a television and video recorders/players or the like. The units are made so that they are universal and can be programmed for the majority of televisions available on the market today. The operation is made by sending an infrared signal from the control unit to an infrared receiver on the television, video recorders/players or the like. Remote controls are used to change channels, volume control, on/off control and 5 many features that different televisions are equipped with today. These remote control units are usually equipped with push button selector switch for changing the channels or to adjust the volume of the television, video recorders/players or the like. In many occasions especially while the viewer is watching a certain TV program, the remote controller in most cases are laid upside down on the sofa, bed or the like where the viewer is also sitting or lying down. And while watching a great scene on the TV, in some occasions the viewer would move and accidentally press down a pillow where the remote controller is usually placed. This actually causes the pressing of the keypad, particularly the 15 channel button which results to the sudden change of the channel at the midst of a great scene. Most of the time when this happens the viewer would immediately look for the remote controller, and when the viewer finds it and returns back to the channel he is watching the great scene is already finished.

The primary object of this utility model therefore is to provide a remote controller for televisions having a keypad protector to prevent the accidental pressing of the buttons of said keypad which may cause the sudden change of said channel while a viewer is watching a certain TV program.

Another object of this utility model is to provide a remote controller for televisions, video players, air conditioners and the like with a keypad protector being defined by a pair of perpendicular projection disposed at the opposing ends of the housing of said remote controller.

Yet, an object of this utility model is to provide a remote controller for televisions with a keypad protector that is easy to manufacture using simple and ordinary equipment.

These and other objects and advantages will come to view and be understood upon a reading of the detailed description when taken in conjunction with the accompanying drawing thereof.

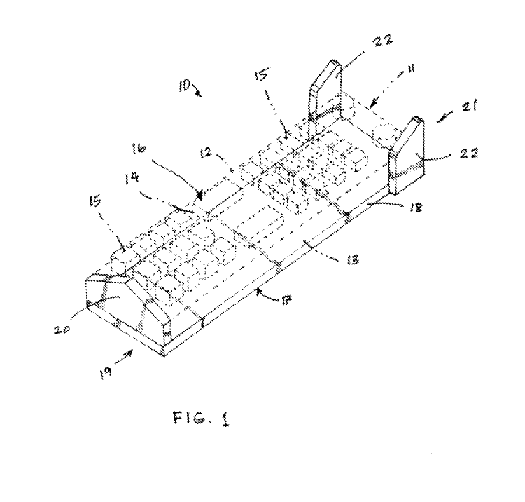

FIG. 1 is a perspective view of the remote controller for televisions, video players, air conditioners and the like according to the present utility model;

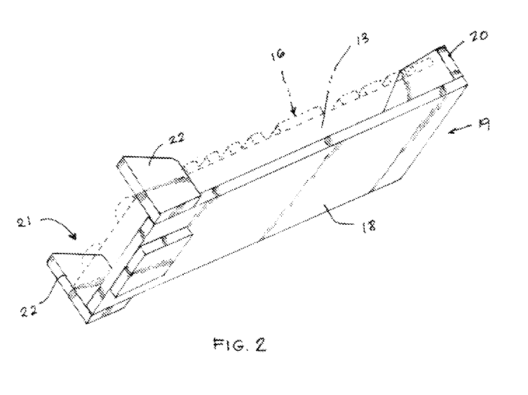

FIG. 2 is a bottom perspective view of the said remote controller; and

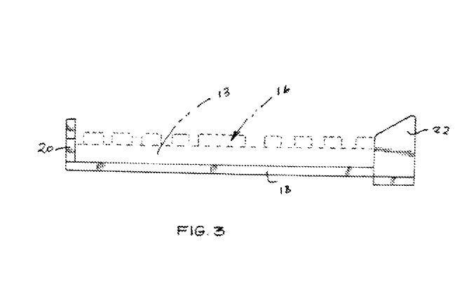

FIG. 3 is a side view thereof.

Referring now to the several views of the drawing, wherein like reference numeral designates same part throughout. Shown is a utility model for a remote controller for televisions, video players, air conditioners and the like with a keypad protector generally designated as reference numeral 10.

Said remote controller 10 comprises an elongated generally flat housing 11 (shown in dotted lines) being defined by a pair of upper and lower shells 12 and 13, said upper shell 12 is provided with a plurality of different kinds of slots 14 adapted to receive different sizes of push buttons 15 of a keypad 16 intended for changing channels and for setting up of different kinds of program activities, such as on/off button, mute button or for accessing the menu options.

The new feature of this utility model is the keypad protector 17 which comprises of a flat rectangular support 18 provided at the back portion of the remote controller housing 11. As shown in the drawings, the forward end 19 of said rectangular support 18 is provided with a protecting block 20 having chamfered corners to provide a way to roll said remote controller in a lying position, should it be laid down in an upside down position, and a pair of opposing raised members 22 extending upwardly from the rear end 21 of said rectangular support 18 is provided. Said pair of opposing raised members 22 and the protecting block 20 functions to prevent the buttons of the keypad from an accidental press when said remote control is in an upside down position or if the remote controller is caught under a pillow or the like and would 5 be pressed whenever the viewer would lie down on said pillow or the like.

1. A remote controller for televisions, video recorders/players, air conditioners and the like with a keypad protector comprising of an elongated generally flat housing, being defined by a pair of upper and lower shells, a plurality of different kinds of slots provided on said upper shell, a keypad having different sizes of pushbuttons being received by the plurality of different kind of slots of said upper shell, said keypad being intended for changing channels and for setting up of different kinds of program activities, such as on/off button, mute button or for accessing the menu options thereof, characterized in that said housing further provided with a keypad protector being defined by a flat rectangular support disposed at the back portion thereof, a pair of opposing raised members extending outwardly from the rear end of said rectangular support, and a protecting block being provided at the opposing forward end of said rectangular support, said protecting block having chamfered corners to provide a way to roll said remote controller in a lying position should it be laid down in an upside down position thereof.

2. A remote controller for televisions, video recorders/players, air conditioners and the like with keypad protector according claim 1.
